(19) United States
(12) Patent Application Publication
(10) Pub. No.: US 2008/0010653 A1
(43) Pub. Date: Jan. 10, 2008

(54) Method and Apparatus for Controlling Access to and Usage of a Digital Media Object

(75) Inventors: Ville OLLIKAINEN, Espoo (FI); Juhani Latvakoski, Oulo (FI)

Correspondence Address: SALTAMAR INNOVATIONS, 30 FERN LANE, SOUTH PORTLAND, ME, 04106, US

(73) Assignee: VALTION TEKNILLINEN TUTKIMUSKESKUS, Espoo (FI)

(21) Appl. No.: 11/768,388

(22) Filed: Jun. 26, 2007

(30) Foreign Application Priority Data
Jun. 29, 2006 (FI) 20065452

(51) Int. Cl. H04N 7/16

(52) U.S. Cl. 725/25

(57) ABSTRACT

A drawback of applying DRM to a mass-distributed digital media object resides in that it is difficult to find out a user who has stored the media object and then distributed illegal copies thereof. This can be prevented by extracting selected portions of data from a stream of an original digital media object and then mass distributing the remaining incomplete media object. Responsive to a user's request for the extracted portions, the extracted portions are first watermarked with user-specific watermarks and then transmitted via a bidirectional communication channel to a user terminal. The terminal then inserts the watermarked portions into their original positions in the incomplete media object so reproducing the original digital media object.

### FIELD OF THE INVENTION

The invention relates in general to delivery of digital audio and video objects via a distribution network to terminals and, in particular, to control of unauthorized distribution of copies of an object. Particularly the invention relates to transmission of digital audio and video objects to mobile terminals capable of receiving mobile TV services.

### BACKGROUND OF THE INVENTION

In these specifications, all digital sound and image recordings and transmissions that are handled as one entity will be called “digital media objects”. Thus, an object may be a picture, sound effect, music, film, animation, radio program, multimedia program or other corresponding entity which can be transmitted, stored and reproduced to a user as such and/or together with other corresponding objects. Computer programs that are broadcast in file format can also be considered objects. By transmission it is meant not only broadcasting, where a transmitting station electrically distributes objects to a plurality of receivers on a regular basis, but also distribution of a digital media object via a computer network. Even delivery of an object on a concrete medium like a DVD to users may be regarded as transmission. By making a stream it is meant conversion of a digital media object into a stream of successive data elements supplied over time. The elements may be packets or frames, for example.

Future portable terminals will be equipped with high-resolution displays and improved audio and video capabilities. Accordingly, future services require that the amount of data to be transmitted is far higher than needed for currently used services for handheld terminals. Although the mobile network of the third generation (UMTS, for example) is more powerful than the network of the second generation (GSM/GPRS), it still encounters limitations in the transmission of larger files or streams having audio/video content to various users at the same time. Thus, it appears that the capability of existing communication systems is not satisfactory for new services.

An example of the above-mentioned services is mobile digital television (Mobile TV for short) that is expected to become the next high growth consumer technology. Mobile TV is intended for a number of different devices and is not restricted to television on mobile phones. Naturally a mobile television receiver can be a mobile phone, but it may also be for example a dedicated terminal placed in a car, a laptop computer or a PDA.

Although 3G operators offer today video on mobile phones in the form of video images (music videos, animated sequences, programme excerpts), which can be downloaded or viewed in streaming on a mobile phone, such a video is not mobile television in the strict sense because mobile television involves accessing continuously broadcast television channels by means of a portable receiver. By using a hybrid network consisting of both a mobile and a broadcast network (for example UMTS/DVB-H) capacity limitations of 3G networks could be overcome. While video on mobiles may make use of the 3G or 2G telecommunications network on the basis of a point-to-point connection, mobile digital television uses the same broadcasting network as fixed television, which is dedicated to “point-to-multipoint” transmissions. This is because, in order to broadcast continuously the same programme to a wide audience, it seems at present to be more competitive to cover an area with a television transmitter than to make use of an individualized connection via the telecommunications network. A television transmitter can cover large areas without gaps wherein disturbances in viewing experience are avoided although a user is moving.

Many of multimedia services will be asymmetric and interactive, wherein users receive large amounts of data. Therefore, broadcast systems would be more to serve these users. However, broadcast networks provide broadband access serving many users simultaneously but they do not support interactivity. The combination of unicast (bidirectional point-to-point) and broadcast (unidirectional point-to-multipoint) networks to form a hybrid network could provide both broadband accesses to many users and also individual interactive channels. Such a hybrid mobile communication networks, including unicast and broadcast delivery systems, may consist of UMTS (Universal Mobile Telecommunications System) and DVB-H (Digital Video Broadcasting—Handheld), respectively. DVB-H is an open standard based on broadcast system DVB-T (Digital Video Broadcasting—Terrestrial). It is optimized for small devices such as mobile phones by using time slicing for less power consumption and an additional forward error correction. Other mobile digital TV transmission standards are also used in addition to DVB-H. MediaFLO (Media Forward Link Only) is a proprietary standard developed by Qualcomm of the US. T-DMB and DAB-IP, which are updated versions of the DAB (Digital Audio Broadcast) system, are currently used in South Korea and in Great Britain. Other standards may also emerge; for example China's broadcast industry regulator has announced that it will require mobile phone service providers in China to use a China-developed technology standard for broadcasting television signals to mobile phones.

Common to all the above-mentioned broadcast networks is that they stream content in packets. Some of them are IP based broadband networks, wherein digital content formats, software applications, programming interfaces and multimedia services are combined through IP (Internet Protocol) with digital broadcasting. Therefore any kind of digital content may be encapsulated in DVB datagram (or any other broadcast standard datagram) as IP packets, which are the same format used to transfer digital content on the Internet. The combination of a broadcast radio transmission technology with the Internet Protocol (IP) is called IP Datacast. The IP layer common with the Internet and the broadcast network means that applications, content format and middleware technologies developed for the Internet can be applied in IPDC (Internet Protocol Datacast) terminals as well.

FIG. 1 depicts an architectural model for a hybrid network. A broadcast operator maintains and manages a broadcast TV network that is DVB-T/H in this example, whereas a mobile operator maintains and manages a cellular network comprising of a core network and a radio access network. The cellular network may be a 2G network like a GSM/GPRS network or a 3G network like UMTS. A service platform refers generally to broadcast service providers and Internet service providers which provide various contents to be played out into the broadcast channel. The broadcast operator transmits content data (for example games, video and audio files or computer programs) simultaneously via transmitters to multiple mobile television receivers that are mobile phones, dedicated terminals, laptop computers etc. Depending on the structure of the hybrid network there may be a number of cells of the mobile network coinciding with just one cell of the hybrid network.

A subsystem, a mediation platform, insures control and signalling between the parties involved in the provision of the services on the hybrid network.

A broadcast program terminal is provided with an electronic service guide (ESG) for detecting, using ESG data, broadcast programs being currently broadcast and displaying broadcast program information.

Irrespective of underlying mobile TV transmission standards users will watch their favourite programmes. However, several studies indicate that a session of watching mobile digital television is short, typically between 5 and 15 minutes. This is quite different from the program length in ordinary television. However, program brands in ordinary television are strong and probably people would like to see them also in their mobile TV, although they in general represent longer format. Doing a separate short format production of a program brand for mobile TV is expensive and not feasible as long as the number of viewers remains low.

Another feature relating to watching mobile TV relates to scheduling. In contrast to an average television viewer who may be willing to adjust his living to match ordinary TV program schedules, a user will watch mobile TV when there is consumable time and a suitable place available.

From a content provider's angle there are some problems concerning mobile TV. One problem relates to making a profit from a broadcast transmission whereas another problem relates to copyright, i.e. how to prevent mobile TV users from spreading copies of broadcast transmissions such as movies.

Since service providers will not want to give content away for free, a straightforward solution to the first problem is to encrypt the transmission and acquire subscribers to an encrypted digital channel wherein a subscriber must purchase and install a decryption module or software into the mobile TV device, and in addition, pay a monthly subscription fee. That kind of solution is well known as conditional access (CA) technology. There are numerous digital video broadcast (DVB)-compliant CA systems available for a broadcaster to choose from.

A solution to the other problem is known as Digital Rights Management (DRM), which refers to technologies used by publishers to control access to and usage of digital data. DRM schemes are built on numerous technologies, such as using cryptographic, restricting owners' use of purchased content, using product activation or certificate-based encryption, or applying digital watermarking i.e. placing hidden data on the media.

A drawback of the encrypted transmission is inability of a distributor of a TV channel to advertise the channel by using the channel itself, i.e. pursuant to the encryption it is impossible in live broadcast to present to potential subscribers the content of the channel. Evidently it would be possible to acquire more subscribers if prior to subscription a potential subscriber could watch the channel at least for a while. Moreover, a very attractive prospect to program providers would be a possibility to allow any user to watch a pay TV program with poor quality first, and then, if the program is interesting, to offer a mechanism making it possible to a user to pay for and to continue watching the program with good quality.

A drawback of applying DRM to a broadcast program resides just in the nature of the broadcast; for example, a broadcast movie is intended for all users or a group of users having subscription to the program. Thus, it is almost impossible to identify a user who has stored a movie on the hard disk of the mobile TV and then distributed illegal copies thereof.

Therefore, an objective of the present invention is to provide a method allowing a user to watch a broadcast program but with poor quality and then, after payment, to watch the program with good quality.

Another objective is to provide a method offering mobile-TV operators new sources of revenue, which enables mobile TV viewers to pay for a program either prior to, or at the beginning of, or in the event of the program by using a real time connection to the operator's media server. The method should be applicable also to pay-per-view (PPV) applications.

A further objective is to provide a media server for handling a digital media object to be protected against unauthorized use in such a way that although a user can receive the unencrypted media object and reproduce it with poor quality the user can reproduce the media object with full quality only after subscription or registration.

Still further objective is to provide a media server capable of adding user-specific watermarks to digital media content to be broadcast.

Still another objective is to devise a mobile TV terminal capable of receiving the broadcast unencrypted media object but reproducing it with full quality only after subscription or registration.

### SUMMARY OF THE INVENTION

The objective is achieved by a method in which such portions of data from a stream of an original digital media object are selected by a media server, the absence of which will cause annoying visible disturbances when the digital media object is reproduced in a terminal. Then these selected portions of data are extracted from the digital media object wherein an incomplete digital media object is formed. The incomplete digital media object is delivered via a distribution channel to terminals. The distribution channel could be any channel that is suitable for distributing digital media objects to public either as an electronic signal or stored on a digital medium like a DVD. In one embodiment the mass distribution channel is a terrestrial broadcast digital TV channel. The extracted portions are stored on a memory medium and conveyed via a bidirectional communication channel to a terminal requested of having to get the complete digital media object.

For example, selection of portions to be extracted can be done by analyzing first an MPEG stream to find the first P frame after an I frame in a group of pictures (GOP) and then further analyzing data of the P frame for discovering a portion data describing the central areas of the P frame image. Another alternative is to remove portions of audio stream so that lip synchronization will be lost. This kind of predefined selection specifications may vary from time to time.

After portions of data have been extracted, the stream structure may become formally invalid. One example of a formally invalid stream is an IP stream with missing packets. To maintain compatibility with subsequent distribution systems the extracted portions may be replaced by bogus data in formally valid structure, e.g. adding empty IP frames in the previous example.

Optionally, the replacement portion is formed by changing a value of at least one coding parameter residing in the extracted portion of data. The original stream is encoded to some video compression standard like MPEG4 and therefore includes coding parameters of macro-block modes, sub-macroblock modes, motion vectors, reference picture indices, intra prediction modes, and transform coefficient levels. Thus, a change of the value of at least parameter causes visible or audible errors in the reproduced digital media object.

Because a terminal is not able to reproduce the digital media object received from a distribution channel with full quality, a user sends via a bidirectional communication network a request for the extracted portions. The extracted portions are then digitally watermarked with user-specific watermarks and the user-specific watermarks information is stored in a memory. Then the watermarked portions are sent via the bidirectional channel to the terminal, which then inserts the extracted portions into the streaming incomplete digital media object and so reproduces the complete digital media object. Thus, any terminal that is the origin of unauthorized copies of the digital media object is traceable.

Optionally, the digital media object is divided into segments having a particular duration. Then, each segment is divided further into stripes and the stripes are used as the extractable portions of data. Striping can be done without any analysis of the content of a bit stream.

According to the method of the present invention, a terminal receives a streaming incomplete digital media object. The terminal examines the incomplete digital media object for finding a position where a portion of data has been extracted from the complete digital media object and, upon detecting such a position, sends a request via a bidirectional communication network to a media server that responds by sending the extracted portion of data via the same communication network. The terminal inserts the extracted portion into the position of the missing portion of data so regenerating the complete digital media object.

A media server according to the preferred embodiment of the invention comprises an analyzer configured to receive the stream of a digital media object and to analyze the stream for finding a predefined portion of data, and, responsive to said portion of data, to produce a selection signal. An extractor extracts the predefined portion of data from the stream responsive to the selection signal, wherein an incomplete digital media object stream is constructed.

The media server further comprises a distribution network interface adapted to transmit the incomplete digital media object stream to the distribution network for further delivery to user terminals, and a communication network interface adapted to receive through the bidirectional communication network a request for the extracted portion of data and responsive to the request to transmit the packet addressed to the user terminal through the bidirectional communication network, said packet including the extracted portion of data.

A packetizer is operatively connected coupled to the extractor for receiving the extracted portion of data, the packetizer constructed to create the packet containing the extracted portion of data, and a watermarking unit ads a terminal-specific watermark to the extracted portion of data.

Optionally, the media server further comprises a replacement forming block operatively coupled to the extractor and adapted to form a replacement of the extracted portion of data, and an inserter adapted to receive the replacement and to insert it in place of the extracted portion of data, thus making the incomplete digital media object stream conformant with the transmission standard.

Optionally information about next coming locations of extracted data is incorporated into the replacement data. This can be accomplished, for example, by buffering the incomplete digital media object stream. The locations of extracted data are analyzed before the buffer and the appropriate replacement data is written after the buffer.

A terminal according to the preferred embodiment of the invention comprises

a missing data detector operatively coupled to the distribution network receiver of the terminal for receiving a streaming digital media object therefrom, and for producing a notification signal in response to detection of a position of an extracted portion of data,

A requester having access to a bidirectional communication network, for transmitting a request for the extracted portion of data to a media server in response to the notification signal,

An insertion block for inserting the extracted portion of data received from the media server through a bidirectional communication network into the position detected, wherein the complete digital media object is formed.

The missing data detector can detect missing portions of data by keeping track of the consecutive numbers of the packets received, wherein a missing packet number triggers the notification signal. Alternately, the missing packet detector can identify predefined replacement packets, wherein identification of the replacement packet triggers the notification signal

In case information about locations of next coming extracted data portions has been incorporated into replacement packets, the terminals reads the replacement packet data and pre-fetches extracted portions of data in advance. This pre-fetch may take place in bursts, which extends battery life in battery-powered terminals.

The proposed methods and devices are applicable for networks where data is transmitted in packets, wherein the digital media content arriving to the media server is streamed in packets and the portions of data to be extracted and transmitted via the mobile network are packets. The mass distribution network may be a digital broadcast network, for example a digital television network or a mobile TV network, but also a peer-to-peer network within a computer network.

For bidirectional communication any network offering bidirectional packet transmission is usable, such as the Internet and a mobile digital network.

### BRIEF DESCRIPTION OF THE DRAWINGS

In the drawings,

FIG. 1 depicts an architectural model for a hybrid network,

FIG. 2 illustrates the principle of the invention,

FIG. 3 is a flow chart of method steps of the invention,

FIG. 4 depicts functional blocks of the media server,

FIG. 5 depicts functional blocks of a mobile TV terminal,

FIG. 6 illustrates segmentation and striping,

FIG. 7 illustrates transmission of striped programs, and

FIG. 8 illustrates transmission of striped programs via a mesh/peer-to-peer network.

### DETAILED DESCRIPTION OF THE INVENTION

FIG. 2 illustrates the general principle of the invention. Extracting device 21 in a media server removes selected fragments from a digital media object that can be a movie, for instance. Prior to extracting the object must be in or it must be transformed into a digital data stream. Removing takes place more or less periodically as the stream is progressing and extracted fragments are stored on storage medium 22 that can be a volatile or non-volatile memory. Due to a small amount of data that is removed from the digital media object a need for the memory size is low. Extracted fragments are only a minor part of the whole data, typically a few percents only. Major part of the data of the digital media object is adapted in unit 23 to a suitable form for mass distribution. This part may be defined as an incomplete digital media object and the form may be a physical one, for instance a non-volatile memory like optical disc storing said data wherein the uni-directional mass distribution channel 24 comprises of retail dealers. In that case presentation apparatuses 25-27 include DVD readers.

Preferably the form is an electrical signal converted to a suitable form for broadcasting in a digital TV network, wherein the unidirectional mass distribution channel is a digital TV channel. Thus, any presentation apparatuses 25-27 capable of receiving broadcast transmissions can receive, decode, and present the digital media object on a display. But because the digital media received is incomplete, quality of the presentation is low: high enough to get a reasonable concept of the content of the media but low enough to make watching unpleasant to a watcher.

The terminal 27 is provided with a unit for wireless bidirectional communication and if a user wants to watch presentation of the digital media object with high quality, the user sends a request for the extracted fragments to the media server via a communication network that may be a mobile network, for example. In response to the request a stream of the extracted fragments is sent via the communication network to the terminal, which then inserts the fragments into their original location. Thereafter the complete digital media content can be presented with high quality on the display.

If the incomplete digital media object is stored on a DVD then insertion of the extracted fragments may be done when loading data from the disk to a buffer memory.

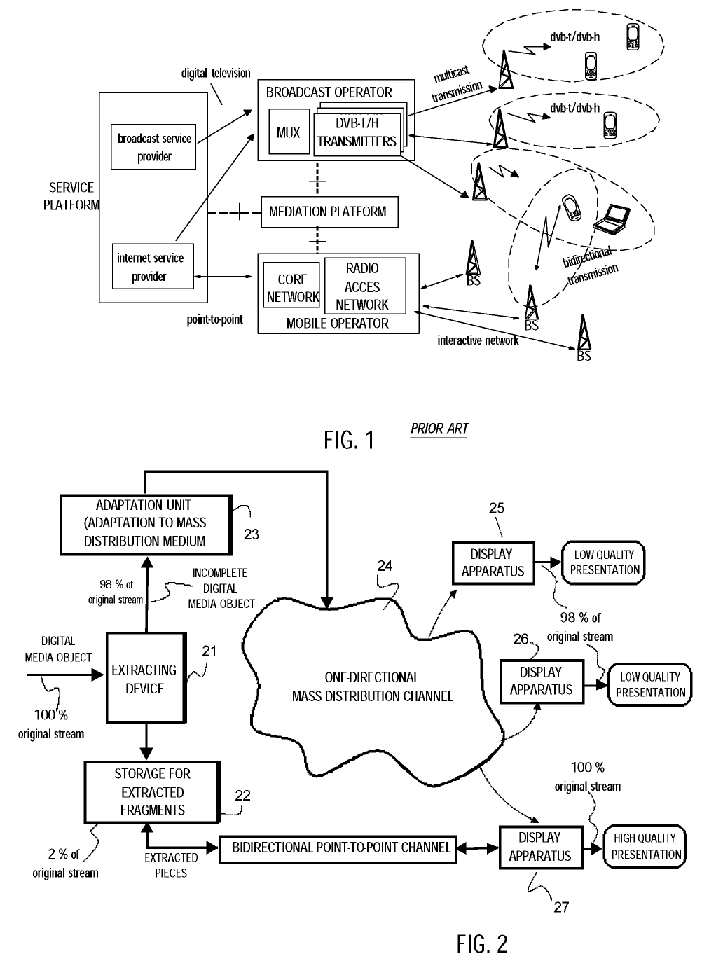

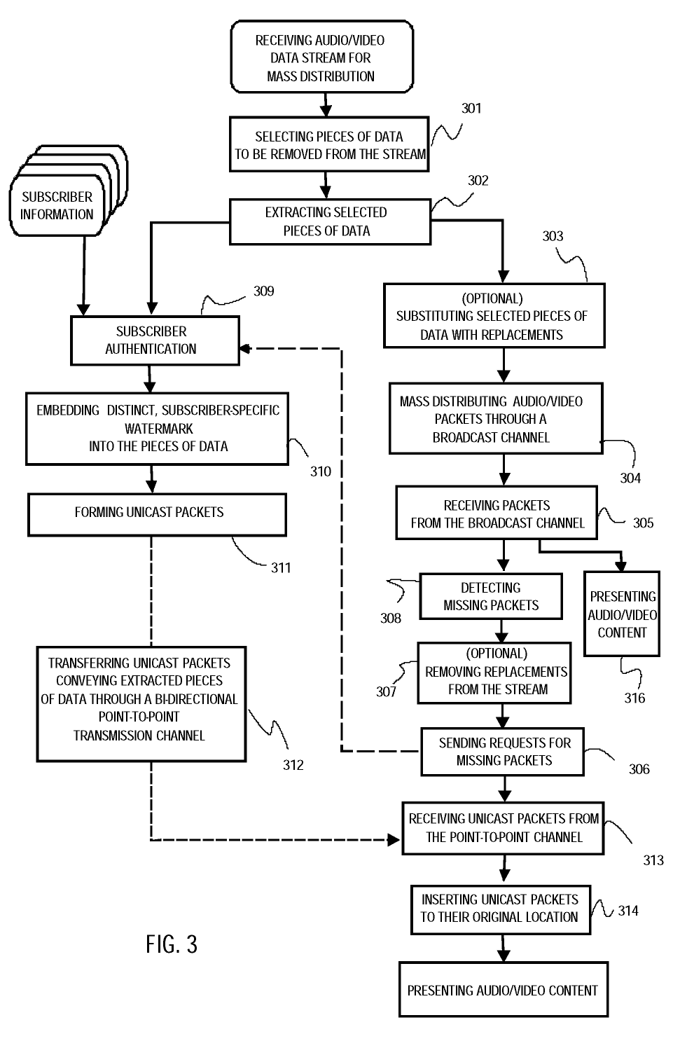

FIG. 3 illustrated method steps of the preferred embodiment of invention. Assuming a media server receives from a broadcast service provider (see FIG. 1) a data stream of a digital media object for further delivery via mass distribution, the media server first selects portions of data to be removed from the stream; step 301. Selection is based on an analysis of the content of data received. The purpose is to extract data from the data stream only in such an amount that although a user can to some extent listen or watch the presentation of the media object in a terminal, perception is unpleasant enough to encourage the user to pay for a high quality presentation. Thus, as to the music it might be enough to extract data representing a certain bandwidth; low, medium, or high tones, for instance. However, the extracted data remarkably lowers quality of the reproduced media object but does not make it impossible to listen or watch it. Proper selection of the analysis criterion allows adjustment of quality of the reproduced media object to a desired level.

It is advantageous if the data stream to be analyzed has some clear structure. For instance, in MPEG-2 an elementary video stream is simply a continuous set of video frames. It is known from the art that the elementary stream is split into packets in order to make the multiplexing process easier at a broadcaster's site. At the start of each packet is a package identifier (PID) informing whether a packet belongs to a video stream or to an audio stream. At the broadcaster's site the resulting packetized elementary stream is packetized again by storing the data from the elementary streams in transport packets. Each transport packet has a length of 188 bytes which is smaller that the length of a packet of the packetized elementary stream.

Keeping in mind the explanation above, it is clear that the analysis can be applied either to the stream prior to its packetizing or to packets. In the first case and if the media object is video then removing now and then a whole P-frame makes it impossible in a receiver to decode subsequent frames until the next I-frame arrives. An amount of data in a P-frame is small thus resulting a very small amount of data to be extracted in comparison to the amount of whole data of the movie. In the latter case, removing packets that include a whole P-frame makes it impossible to decode subsequent frames in the receiver.

Referring back to FIG. 3, applying the selected criterion in the analysis results in the discovery of a portion of data and then extraction of the portion, step 302. If the digital media object is packetized then each packet is analysed in real time as the packet arrives, wherein successive extractions result in a minor stream of extracted packets whose total amount may be around 2% of the original stream, for example, whereas the rest of the original packet stream, which is hereafter denoted as the incomplete digital media object, is about 98% of the original packet stream. The extracted packets are stored temporarily on a storage medium. The incomplete digital media object is directed to a broadcaster's system for packetizing in transport packets to be inserted into a broadcasting multiplex and then for mass distributing via a broadcast channel, step 304.

Optionally, the extracted packets can be substituted with replacement packets, step 303. Each replacement packet has the same payload or an empty payload but a replacement packet gets at least the same packet number as the extracted packet in question has. Thus, the incomplete digital media object comprises the same number of packets as the original digital media object.

Alternatively, the replacement portion is formed by changing a value of at least one coding parameter residing in the extracted portion of data. The original stream is encoded to some video compression standard like MPEG4 and therefore includes coding parameters of macro-block modes, sub-macroblock modes, motion vectors, reference picture indices, intra prediction modes, and transform coefficient levels. Thus, a change of the value of at least one parameter causes visible or audible errors in the reproduced digital media object. In this case the replacement packets are marked by adding a special tag to the packet header.

It is worth noting that the incomplete digital media object, which display apparatuses are receiving through a broadcast channel, step 305, is not encrypted. Therefore, any terminal can decode packets and present the object on the display, step 316. However, pursuant to the extracted packets quality of presentation is low and far from being enjoyable to a watcher. Anyhow, quality is high enough so that the user can get a reasonable concept of the content. If the program is interesting, the viewer can ask the media server to “open” the program. This can be done so that the user selects a “subscribe” button on a menu, for example. In response to the selection, the terminal automatically creates and sends via a mobile network a message addressed to the media server, step 306.

In receipt of the message the media server authenticates the terminal to decide if the user or the terminal is allowed to have the digital media object with full quality, step 309. Any known authentication process is applicable and subscriber information stored in a subscriber database may be used. In addition, the media server records every user request along with the identification of the related digital media object.

After the user's request has been accepted, a bidirectional connection from the media server via the mobile network to the terminal is established. The mobile network sets up the connection and receives from the media server packets that were just extracted from the digital media object. When forming a unicast packet, step 311, the target address is the same as the address of the terminal in the mobile network and is obtained from the address field of the request message. Henceforth, every time as a packet is extracted from the stream of packets forming the digital media object, it is inserted into a unicast packet that is transferred via the mobile network to the terminal, step 312.

The terminal receives the unicast packet from the mobile network, step 313, discovers the extracted packet therefrom and inserts said packet into the stream of packets of the incomplete digital media object obtained from the broadcast network. Following the packet numbering the extracted packet is inserted to its original location in the stream of packets, step 314.

In summary, the terminal is receiving the majority of packets of the digital media object from the broadcast network and the minority comprising of extracted packets from the mobile network. Upon receipt, the extracted packets are inserted to their original location wherein a complete packet stream of the original digital media object is reconstituted. Thus, the media object can be presented in full quality on the screen of the terminal, step 315.

Because the digital media content is a broadcast transmission a great number of terminals may simultaneously receive the same digital media content but extracted packets are transmitted individually via a bidirectional channel of the mobile network only to those terminals which are authorized to receive these packet. There is a serious risk that an authorized user may store the high quality digital media object, such as movie, on the hard disk of the terminal and later distribute illegal copies of the media object. An optional feature of the invention allows tracking the source of the illegal copies.

This feature is based on inserting a watermark into the extracted packets individually prior to their transmission to a terminal. Thus, after authentication of a user which requested extracted packets, a unique watermark is created, i.e. an individual watermark is assigned to each user, step 310. Information relating to the watermark and the digital media object is stored in the subscriber database for the associated user.

Any desired watermarking or fingerprinting technique can be used. One option is to use a limited number of watermarks, a so-called watermark pool. Each packet in a defined number of successive extracted packets in a bidirectional connection gets an individual watermark wherein extracted packets travelling via a bidirectional connection are distinguishable from packets travelling via another bidirectional connection by different combinations of subsequent watermarks.

The watermarks are quite transparent to a terminal that has received the extracted packets. Then, if illegal copies of a movie are found, an origin of the copies can easily found by comparing watermarks in the copies with the watermarks stored in the subscriber database. It may be enough to watermark one single packet only because it is sufficient to find one watermark only to proof the source of a copy.

As stated previously, there is an option to substitute the extracted packets with replacement packets, step 303. If that step is taken then the replacement packets must be removed in a terminal, step 307. A replacement packet to be removed may be recognized from a predefined constant bit pattern in the payload or a predefined token in a header field.

Then, after the terminal has sent the request for extracted packets, it starts to monitor the packet stream arriving from the broadcast channel for detecting a missing packet. The location of an extracted packet is detected by monitoring either replacement packets if the replacement option is used or by monitoring packet numbers for a missing packet number, step 308.

There are two alternatives to proceed. Either every time as a missing packet is detected in step 308, a request for the extracted packet is sent to the media server. Or the first request causes the media server to send extracted packets automatically as long as the mobile terminal does not send a “close” message to the media server. Such a message is sent automatically in response to a channel change or shutting down the terminal, for example.

Every time when a packet has been received from the bidirectional channel, it will be inserted to its original location in the stream. Then the digital media object is presented in its original quality on the display.

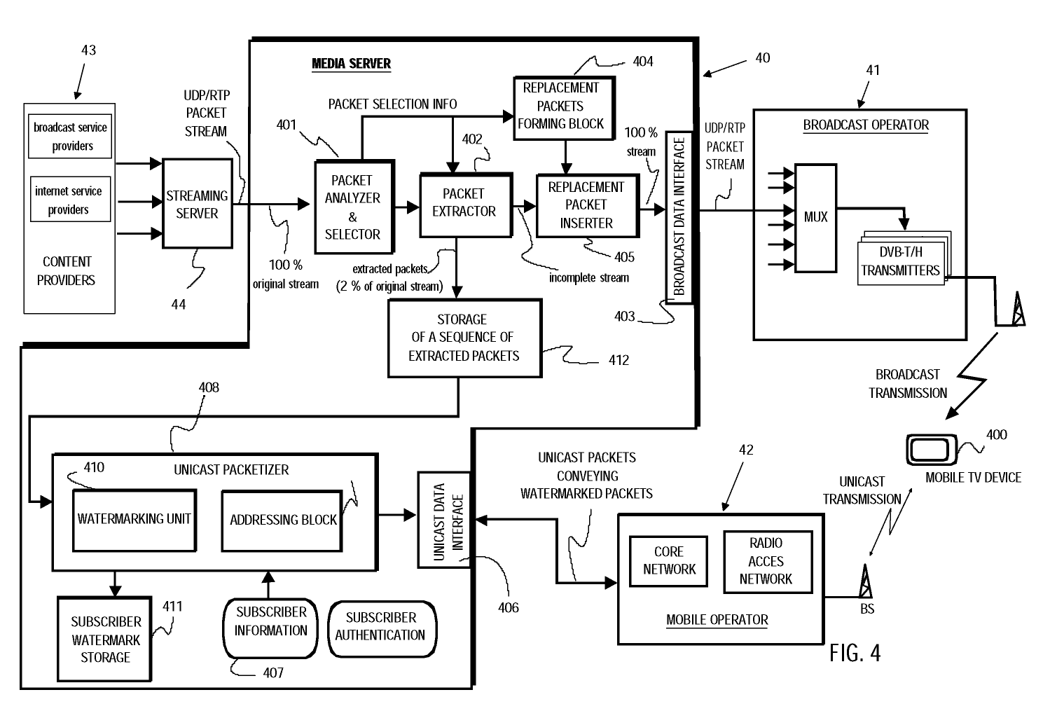

Reference is now made to FIG. 4, which illustrates functional blocks of a media server. Media server 40 operates in conjunction with a mobile operator's network 42 and a broadcast operator's network 41, optionally using an intermediate computer network such as the Internet for communication. Optionally, the media server can also be incorporated into the broadcast operator's network. The media server can communicate via a bi-directional connection with mobile TV device 400 that is provided with a wireless network unit allowing access to the mobile network.

Media server 40 receives various digital media objects from content provider 43, which first packetizes the objects in streaming server 44 into UDP packet for transmission through the Internet.

A digital media object, which is in the form of a packet stream, is first analysed in packet analyser and selector 401. The purpose is to find from each packet a predefined data fragment. For instance, the data packet is analysed for detecting P-frame data thereof. When a packet including such a frame has been found, a packet selection signal is generated. Responsive to the packet selection signal the packet extractor 402 removes from the packet stream the selected packet that is temporarily stored in a storage 412.

The amount of the extracted packets in comparison to the total amount of the streamed digital media object is adjusted, by proper selection of the analysis criterion, to be very low, only a few percents. The major part of the stream, (hereinafter the incomplete digital media object), is transmitted through broadcast data interface 403 to the broadcast system 41 for further broadcasting to receivers, such as mobile TV terminals. Packets of the incomplete digital media object are put into transport packets, which are multiplexed and broadcast. Steps taken at the broadcast operator's site depend on the broadcast system in question and are a matter of technical choice. The operator may use DVB-H system, for example.

In some implementations it might be advantageous to replace the extracted packets with replacement packets. To that end, the media server includes optionally replacement-packet forming block 404. Responsive to the packet selection signal from packet analyzer 401 the replacement-packet forming block 404 creates a replacement packet including the same header as the extracted packet has or at least the packet number remains. The payload of the replacement packet is a predefined bit pattern and every replacement packet has the same payload. Therefore, replacement packets are easily detectable in the packet stream. Replacement packet inserter 405 inserts the replacement packet into the location of the extracted packet in the stream, such that the packet stream of the incomplete digital media object has same number of packets as the original packet stream has. Then the incomplete digital media object including replacement packets are transmitted to the broadcast operator' site.

The media server 40 has also unicast data interface 406 for communicating with mobile network 42. In practice, the intermediate network between the media server and the broadcast operator' site and the mobile network is a computer network, such as the Internet, wherein interfaces 403 and 406 may be merged into a single network interface. However, for clarity reasons the interfaces are handled here separately.

Through the unicast data interface 406 the media server receives from the mobile network a message carrying a request for the extracted portions. The origin of the message is mobile TV device 400 that has sent it to the mobile network for further delivery to the media server. In response to the request the media server first authenticates the user of the mobile TV device. Any known authentication method can be used and possibly several queries and replies are exchanged between the media server and the mobile TV depending on whether the user is a new subscriber or an old one. In the latter case subscriber information is already stored in subscriber information database 407. When the authentication is completed, information about subscriber and a digital media object requested by the subscriber is stored in the database. That information with additional information is used for billing purposes.

Next, unicast packetizer 408 starts to generate packets for the mobile TV, each including in its payload an extracted packet fetched from temporary storage 412. The target address of each unicast packet is obtained from the request message initiating the user authentication. As a unicast message is ready it is transmitted through the unicast data interface to the mobile network 42 that transports the packet further to the mobile TV device 400, which in turn inserts the extracted packet into its original location in the packet stream received from the broadcast network.

From now on, whenever packet extractor 402 removes a packet from the original packet stream, the unicast packetizing block 408 incorporates the extracted packet into a unicast packet, which is transported immediately through the mobile network to the mobile TV device 400. It is worth noting, that unicast transmission of the extracted packets is synchronized with broadcast transmission wherein the mobile TV device is able to present the digital multimedia object in real-time.

The media server includes a watermarking unit 410. The extracted packets are transmitted at the same time perhaps to hundreds or thousands of mobile TV devices. Digital technology makes it possible for a user to record the digital media object in full quality and then spread unlawful copies of other copyrighted work. Watermarking the digital media object can effectively prevent distributing of said copies. Moreover, watermarking each digital media object with a unique, subscriber-specific watermark offers a powerful weapon to track the source of unlawful copies.

To that end, some or all of the extracted packets, more accurately their payloads, may be watermarked prior to transmission. Advantageously watermarks applied to the packets are connection-specific, i.e. each mobile TV receiving the extracted packets through a bidirectional connection also receives connection-specific watermarks therein. Thus, upon completed authentication of a user but prior to transmission of the extracted packets, the media server selects from watermark storage 411 a watermark or a combination of watermarks to be applied only to those extracted packets that are sent to the user. Information on the applied watermarks is stored in subscriber information database 407 in association with the previously mentioned information about the subscriber and the digital multimedia content.

The watermarked extracted portions may be transmitted over a bidirectional radio channel as a flow of subsequent packets. However, it is more efficient to transmit the portions in bursts, each burst containing a plurality of said portions.

As a result of connection-specific watermarking, a specific user whose terminal is the source of unlawful copies can always be identified by comparing watermarks in a copy with the watermarks stored in database 407.

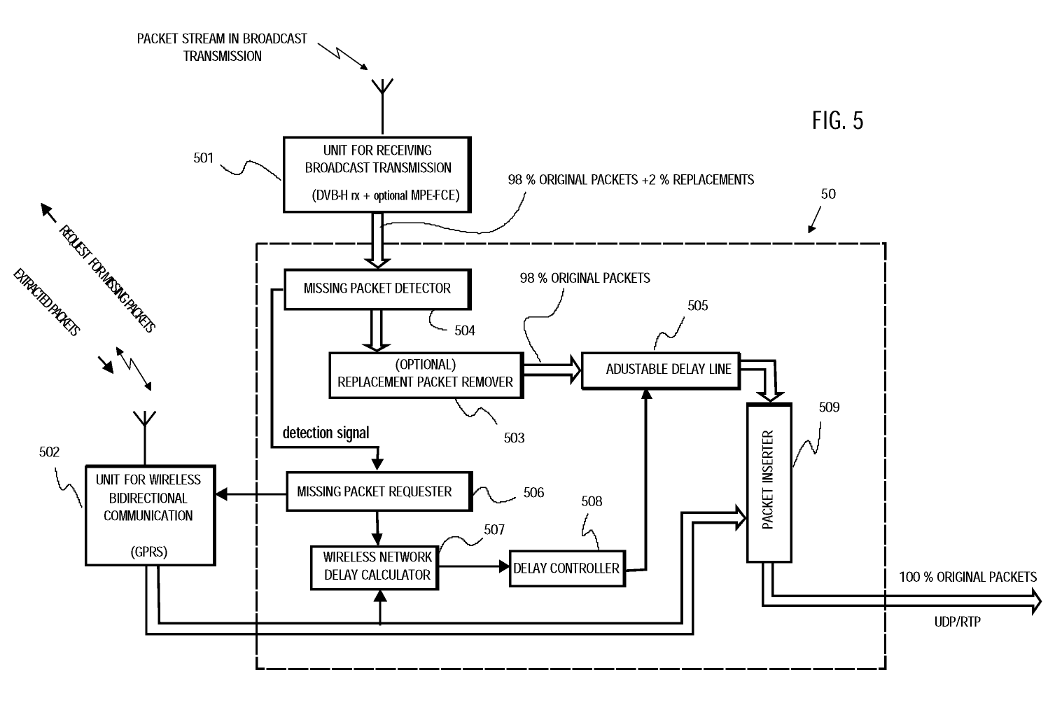

FIG. 5 illustrates additional unit 50 of a terminal to present a digital media object of the invention. The unit operates in conjunction with receiver unit 501 adapted to receive digital broadcast transmissions, for instance DVB-H transmissions, and with wireless radio unit 502 enabling access to a network that offers bidirectional communication channel. Preferably, the network is a mobile network enabling point-to-point packet transmission. Thus, the network could be a 2G network like a GSM/GPRS or a 3G network but also a Wi-Fi network where Wi-fi refers to the underlying technology of wireless local area networks (WLAN).

Receiver unit 501 receives a packet stream of an incomplete digital media object from a broadcast channel, said packets being embedded in transport packets of the broadcast system considered. Receiver unit 501 decodes transmission packets and forwards resulting packet stream of the incomplete media object to the unit 50. There, missing packet detector 503 examines every packet in order to find those locations in the packet stream where packets have been extracted. Missing packet can be detected in two ways. The simplest way is to monitor packet numbers of successive packets, wherein always when missing packet detector 504 detects that a number in the number order is missing it produces a detection signal. The signal includes at least the number of the missing packet.

Optionally, the missing packet detector may detect replacement packets if such packets are used to substitute the extracted packet at the transmission end. A replacement packet has the same packet number as the original packet, so detection based on the number order is not usable. But a replacement packet may have a special tag in its header, wherein detection of said tag produces the detection signal. Alternatively, each replacement packet may have the same predefined payload pattern wherein upon detection of such a pattern the detection signal is produced. In both cases the signal includes at least the number of the missing packet.

In case replacement packets are used, replacement packet remover 503 removes such a packet from the packet stream prior to guiding the packet stream to adjustable delay line 505.

The detection signal that missing packet detector 508 produces is an input signal to missing packet requester 506. Responsive to the detection signal the requester forms a request message addressed to the media server. The message contains information that will be sufficient for the media server to identify the digital media content. For that purpose information included into a package identifier (PID) at the start of each transport packet may be used. In addition, the number of the missing packet is told in the request message. After the content of the request message has been completed, the unit for wireless bidirectional communication 502 sends it to the media server.

At the same instant as the message is sent the missing packet requester 506 gives a first enabling pulse to wireless network delay calculator 507. When the extracted (missing) packet arrives the unit for wireless bidirectional communication 502 gives a second enabling pulse to the delay calculator that then calculates the time difference between the enabling pulses. The time difference reflects the delay in the network transmission and is used to delay packets of the incomplete media object in adjustable delay line 505. Thus, wireless network delay calculator 507 produces a control signal that is proportional to the time difference. The control signal is applied, as an input signal, to delay controller 508, which then calculates how long a packet of the incomplete digital media object must wait in the delay line until the extracted packet is expected to arrive from the bidirectional communication channel. Delay controller 508 adjusts that time with an adjustment signal.

After the calculated delay time has lapsed, packets in the delay line will appear in the packet inserter 509 and the extracted packet that has arrived is inserted into its original location in the original packet train.

According to the mechanism describe above, the media server sends each extracted packet via the bidirectional communication channel whereupon the packet is inserted to its original location. The result is a the complete digital media object, i.e. a complete packet stream that is then transferred for further processing and is finally presented on a display.

It is stated in the description above that every time as the missing packet detector 504 has detected that a packet has been extracted, a request for the extracted packet is sent. Alternatively, the request may be sent only once; when the media server has received the first request, it will transmit an extracted packet every time when extraction has been made. In addition, the media server adds to each extracted packet a portion of information about how long the terminal must wait until the next extracted packet is sent. The delay controller 508 of the terminal utilizes this portion of information directly when forming the adjustment signal to the adjustable delay line 505. Transmission of extracted packet is broken off in response to a stop request of the terminal. Alternatively, transmission may be continued during a predefined time or until the TV program will be ended.

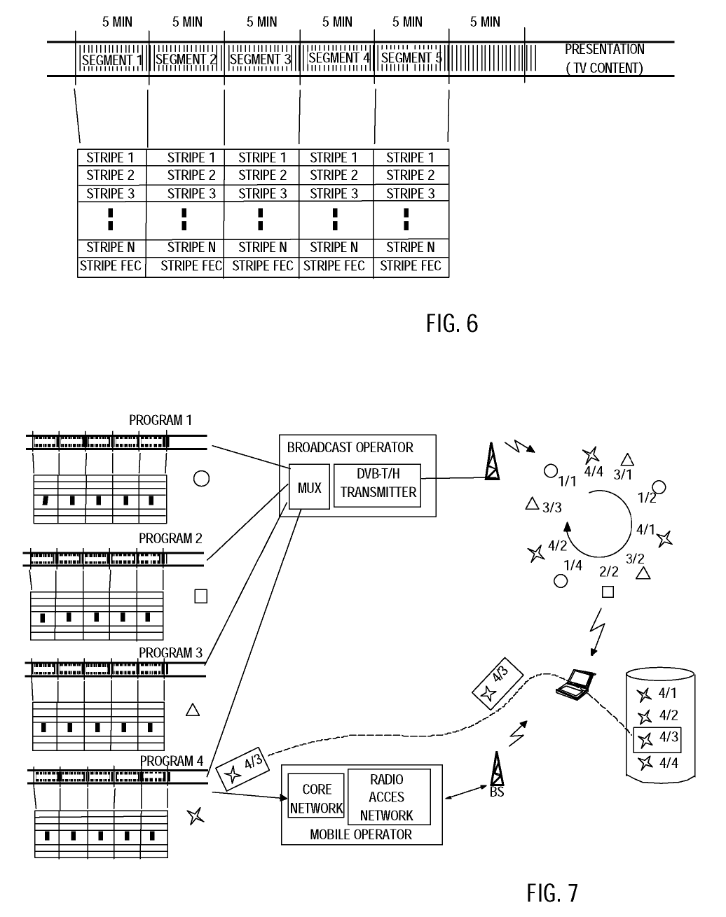

Reference is made to FIG. 6. In the passages relating to FIGS. 3 and 4 attention is not paid to the content of the digital media object. However, efficiency of the invention may be further improved by dividing the media object into segments whose duration is less than, or almost equal to, a typical viewing session of that particular object type. Segments are preferably created so that scene changes are taken into account. Several prior art technologies and algorithms exist for segmentation. In FIG. 6 the upper stripe illustrates presentation of a digital media object, a movie for instance. The object is here divided into segments, each having duration of 5 minutes.

Each segment is further divided into smaller units—stripes as shown in FIG. 6, and the stripes are then packetized and filecasted over a broadcast network, such as DVB-. In the present invention, the striping is combined with segmentation, and only those stripes which belong to the segments about to be viewed in the near future in a terminal, are stored in a memory of the apparatus. The most appropriate segments can be deduced from user preferences. Examples of this kind of process would be as follows: If a user has ordered news, predictably the user will watch the latest news in the near future. If the user has watched segments 1 and 2 from a drama program during the past day, predictably the user will watch at least segments 3 and 4 next. As far as there is enough memory and battery power available, as many segments as possible could be downloaded for the future viewing.

The stripes may contain further forward error correction, as some stripes of a segment may contain redundant data. By having some redundancy, a segment can be restored although not all stripes have been received. This kind of use of redundant data for forward error correction (FEC) is well known in the art.

According to the preferred embodiment of the invention some stripes are not broadcast at all but those stripes are available only over a mobile network. If a user is about to view a segment, whose stripes have not all been stored into the memory of the display, the user can instruct the terminal to order the missing stripes form a media server over the mobile unicast connection. This is illustrated in FIG. 7. The amount of unicast data will be considerably lower in comparison to the case where the whole digital media object would be streamed and transmitted through the mobile network. For example; if 1 stripe out of 100 stripes is missing from the broadcast transmission, and the bit rate of a video is 300 kbps, only 3 kbps payload has to be delivered over a mobile network.

Striping can be arranged without any analysis of the content of a bit stream. A well-known striping method RAID (Redundant Array of Independent Disks) is usable. However, if it takes place by using a more sophisticated scheme, such as including some MPEG I-frames to the unicast stripes, a unique fingerprint can be issued to every unicast stripe. Adding a predetermined least significant bit (LSB) patterns to I-frame macroblocks is one of the most straightforward methods. Fingerprints could be generated by several well-known methods, which exist in the art.

The method of striping a digital media object and individually watermarking the stripes is also applicable in a peer-to-peer arrangement, where a main server keeps track which stripe is available in which p2p content repository. The main server can thus also keep track where each individual stripe is copied to, and consequently can also track the flow of watermarks. Now, when a segment is built from several stripes, it may contain several watermarks. If an illegal copy emerges, the main server can track down, which user had got the particular combination of watermarks.

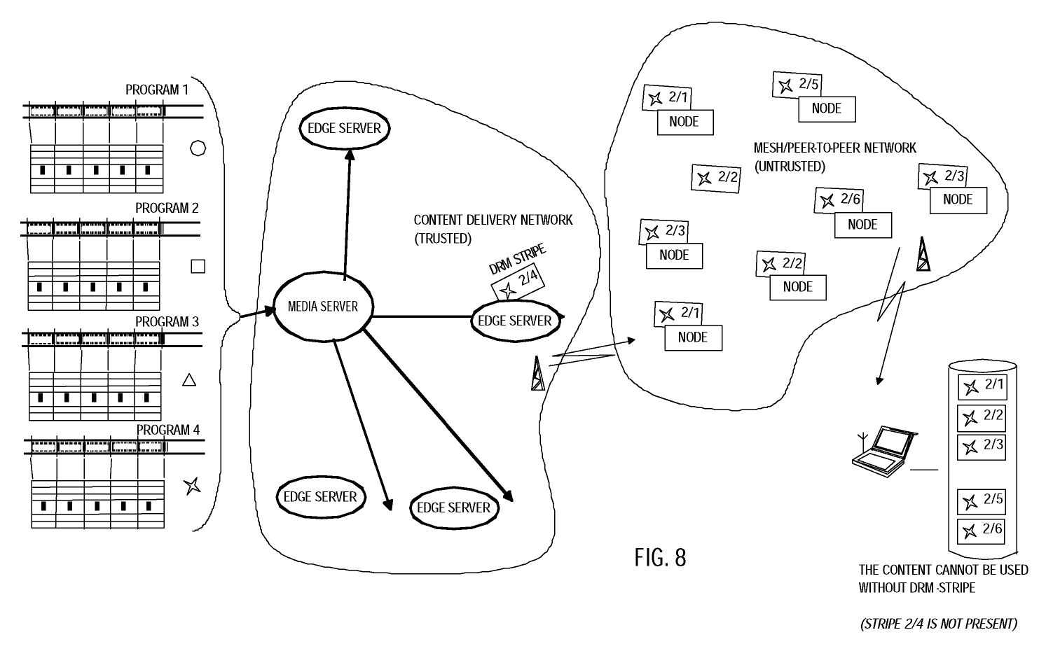

FIG. 8 represents yet another optional aspect of the invention, which visualizes content delivery from a media server on a trusted IP based network over a non trusted mesh network/peer-to-peer network to a mobile television terminal. First, the content is delivered from the media server to an edge server that is located near the not trusted network but still belongs to the trusted network. The edge servers may host the content Digital Rights Management (DRM) stripe, and allow the other stripes (encrypted) to be delivered freely via the mesh/p2p networks. Each encrypted stripe contains identification of the metadata related to the actual content segment e.g. program name.

When a user would like to see some content, he can freely download any video or TV content from the mesh/p2p network. However, without the DRM stripe the user cannot view the content, unless he has the DRM stripe with proper authorization. The DRM stripe is stored in the trusted network and the user can download it only after authentication. In this way the content provider, who has control over the DRM stripes, is enabled to get payments from each download of the content.

Although DVB-H has been presented as a mobile broadcast network, other networks such as T-DMB and DAB-IP as well as MBMS can be used. It should be noted that MBMS will be a technology for 3G networks, whereas the missing packets can be retrieved from 2.5G (e.g. GPRS) with better coverage.

The method is also applicable in an IPTV (Internet Protocol Television) system, where a viewer through the technologies used for computer networks receives television content. In that case both the distribution channel and the bidirectional channel share the same physical medium.

1. A method for handling a data stream representative of a digital media object to be protected against unauthorized use, wherein the digital media object is made available via a distribution channel to a plurality of user terminals, the method comprising the steps of:
selecting portions of data from the stream;
forming an incomplete digital media object stream by extracting the selected portions of data from the stream, wherein the incomplete digital media object will, when reproduced, produce a low quality reproduction;
converting the incomplete digital media object stream into a format suitable for a distribution channel and distributing the converted incomplete digital media object stream via the distribution channel;
storing the extracted portions;
in response to a user terminal's request received via a bidirectional communication channel, digitally watermarking the extracted portions with a user-specific watermark; and,
transmitting the watermarked extracted portions through the bidirectional communication channel to the user terminal, for the terminal to insert the extracted portions into the stream of incomplete digital media object, such that the original digital media object may be reconstructed.

2. The method as in claims 1, further comprising the step of:
storing information about the user-specific watermark, wherein a user that is the origin of unauthorized copies of the digital media object is traceable.

3. The method as in claim 1, wherein transmission of the extracted portions is timed with distribution of the converted digital media object stream.

4. The method as in claim 1, further comprising the steps of:
checking user's rights from a subscriber database, and
transmitting the extracted portions to the user terminal only when the user has the right to reproduce the complete digital media object.

5. The method as in claim 1, wherein each of the extracted portions is substituted with a replacement portion.

6. The method as in claim 5, wherein
the replacement portion is formed by changing a value of at least one coding parameter residing in the extracted portion of data;
the coding parameter being selected from a group consisting of macroblock modes, sub-macroblock modes, motion vectors, reference picture indices, intra prediction modes, transform coefficient levels, or any combination thereof; and,
wherein decoding of the replacement portion causes errors in the reproduced digital media object.

7. The method as in claim 5, wherein the replacement portion comprises information about the location of at least the subsequent replacement portion in the incomplete digital media object stream.

8. The method as in claim 1, wherein the extracted portions are transmitted prior to distribution of the incomplete digital media object.

9. The method as in claim 1, wherein the watermarked extracted portions are transmitted in bursts via the bidirectional communication channel, each burst containing a plurality of said portions.

10. The method as in claim 1, wherein the extracted portions are encrypted.

11. The method as in claim 1, wherein the distribution channel is a peer-to-peer network, and wherein the step of transmitting the watermarked extracted portions is preformed from at least one authorized peer residing in a trusted domain of the peer-to-peer network.

12. The method as in claim 1, wherein each extracted portion of data is a packet of the stream of the digital media object.

13. The method as in claim 12, wherein the packet comprises data from a forward prediction (P) frame of the digital media object, which is MPEG-compressed.

14. The method as in claim 1, further comprising the steps of:
dividing the stream of the digital media object into segments having a particular duration,
further dividing each segment into stripes, and
using at least one of the stripes as the selected portions of data.

15. A method of reproducing a digital media object received by a user terminal as a streaming incomplete digital media object from a distribution channel, the incomplete digital media object having been produced from an original media object by extracting data portions thereof, the method comprising the steps of:
in the incomplete digital media object, detecting a position where a data portion has been extracted from the original media object;
responsive to detection of the position, receiving a corresponding extracted data portion via a bidirectional communication channel; and,
inserting into said position the extracted data portion;
wherein the extracted portion is addressed to the user terminal.

16. The method as in claim 15, wherein detection is based on tracing a predetermined replacement pattern in the streaming incomplete digital media object, wherein said replacement pattern is an indication of the position of the extracted data portion.

17. The method as in claim 15, wherein detection is based on keeping track of packet numbers in the streaming incomplete digital media object, wherein a missing number indicates a position of the extracted data portion.

18. The method as in claim 15, wherein detection is based on examining packet header information, wherein the extracted data portion is indicated in the header information of the packet.

19. The method as in claim 15, further comprising the steps of:
gaining scheduling data from the extracted portion of data received via the bidirectional communications channel, the scheduling data being indicative of the position of the subsequent extracted portion of data in the incomplete digital media stream,
triggering the step of detection by monitoring the data stream of the incomplete digital media object according to the scheduling data.

20. The method as in claim 15, wherein
responsive to switching the user terminal to the distribution channel:
sending a subscription message via the bidirectional communication channel to a media server;
receiving extracted portions of data until switching off the distribution channel.

21. A media server for handling a stream of a digital media object to be protected against unauthorized use, the media server operating in conjunction with a distribution network for distributing the digital media object to terminals, and in conjunction with a bidirectional communication network providing a bi-directional channel between the media server and a specific user terminal, the media server comprising
an analyzer configured to receive the stream of a digital media object and to analyze the stream for finding a predefined portion of data, and, responsive to said portion of data, to produce a selection signal;
an extractor for extracting the predefined portion of data from the stream, responsive to the selection signal, wherein the original digital media object is converted to an incomplete digital media object stream by extracting the data portion;
a distribution network interface adapted to transmit the incomplete digital media object stream to the distribution network for further delivery to user terminals;
a communication network interface adapted to receive through the bidirectional communication network a request for the extracted portion of data and responsive to the request to transmit a packet addressed to the user terminal through the bidirectional communication network, the packet containing the extracted portion of data;
a packetizer operatively coupled to the extractor for receiving the extracted portion of data, and constructed to create the packet containing the extracted portion of data; and,
a watermarking module for adding a terminal -specific watermark to the extracted portion of data.

22. The media server as in claim 21, the media server further comprising
a replacement packet-forming block operatively coupled to the extractor and constructed to form a replacement portion;
a replacement inserter constructed to receive the replacement portion and to insert it in place of the extracted portion of data.

23. The media server as in claim 22, wherein
the replacement packet-forming produces the replacement portion by changing a value of at least one coding parameter residing in the extracted portion of data;
the coding parameter is being selected from a group consisting of macroblock modes, sub-macroblock modes, motion vectors, reference picture indices, intra prediction modes, transform coefficient levels, and a combination thereof;
wherein decoding of the replacement portion causes errors in the reproduced digital media object.

24. The media server as in claim 21, wherein the watermarking module selects the watermark from a group of watermarks, wherein the packets sent to different terminals are by different combinations of the watermarks.

25. The media server as in claim 21, further comprising a subscriber authentication unit for authentication of the terminal requesting the extracted portion.

26. The media server as in claim 21 wherein the analyzer is configured to analyze packets for finding predefined packets, wherein the extracted portion of data is a packet.

27. The media server as in claim 26, wherein the amount of the predefined packets are determined to consist of around 2% of the packet stream.

28. The media server as in claim 21, further comprising a watermark storage for storing terminal-specific information about the watermarks added into the extracted portions of data sent to the terminals.

29. A user terminal having a distribution network receiver for receiving a transmission of a streaming digital media object and a packet transceiver for bidirectional communication with a media server, the user terminal comprising
a missing data detector operatively coupled to the distribution network receiver for a receiving the streaming digital media object, and for producing a notification signal in response to detection of a position of an extracted portion of data;
a requester operatively coupled to the packet transceiver, for transmitting a request for the extracted portion of data to a media server in response to the notification signal;
an inserter for receiving from the bidirectional communication network the extracted portion of data and for inserting it into the position detected, wherein the complete digital media object is formed.

30. The terminal as in claim 29, wherein the missing data detector is constructed to keep track of the consecutive numbers of the packets received, wherein a missing number triggers the notification signal.

31. The terminal as in claim 29, wherein the missing data detector is constructed to identify predefined replacement portions having the same content, wherein each replacement portion identified triggers the notification signal.

32. The terminal as in claim 29, wherein the missing data detector is constructed to examine packet header information, wherein a predefined tag found in the header triggers the notification signal.

33. The terminal as in claim 29, further comprising a remover for removing the replacement portion from the streaming digital media object stream.

34. The terminal as in claim 29, further comprising an adjustable delay line functionally coupled before the inserter, for delaying the streaming digital media object stream responsive to a delay control signal.

35. The terminal as in claim 34, further comprising a delay calculator for calculating the delay from sending the request for the extracted portion of data to reception of said port, wherein the delay control signal is produced in relation to the delay.
